(19) United States
(12) Patent Application Publication
(10) Pub. No.: US 2009/0048821 A1
(43) Pub. Date: Feb. 19, 2009

(54) MOBILE LANGUAGE INTERPRETER WITH TEXT TO SPEECH

(75) Inventors: Shuk Yin Yam, Causeway Bay (CN); Jeong Sik Jang, Kyeonggi-Do (KR)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 12/131,865

(22) Filed: Jun. 2, 2008

Related U.S. Application Data
(63) Continuation-in-part of application No. 11/190,685, filed on Jul. 27, 2005.

(51) Int. Cl. G06F 17/28; G10L 13/08; G10L 21/00

(52) U.S. Cl. 704/3; 704/260; 704/2; 704/277; 704/8; 704/E13.013

(57) ABSTRACT

Embodiments are directed towards a language learning environment accessible from within virtually any website that enables a user to practice a language using tools such as translators, and text to speech capabilities. In one embodiment, the user may access a webpage in one language, and employ the language widget to select portions of content on the webpage, perform translation of the content, or perform a text to audio (speech) conversion of the selected portions. The text to speech conversion may be performed independent of translation, thereby allowing the user to hear a pronunciation of text within the website in a language associated with the website. The user may download an audio file of the converted text for use in later replay for mobile learning.

### CROSS-REFERENCE TO RELATED APPLICATIONS

The present application is a Continuation-In-Part application to U.S. patent application Ser. No. 11/190,685 entitled “Automatically Generating a Search Result in a Separate Window for a Displayed Symbol That Is Selected with a Drag and Drop Control” filed on Jul. 27, 2005, the benefit of which is hereby claimed, and which is further incorporated by reference herein in its entirety.

### TECHNICAL FIELD

The present invention relates generally to language translators and, more particularly, but not exclusively to enabling providing a language learning environment in which a user practicing a language may be further provided with a real-time language text to speech capability with automatic download for mobile learning.

### BACKGROUND

More and more businesses have become international, often having divisions, in several foreign countries across the globe at the same time. As a result, there is a growing need for employees, at virtually every level of the business, to be able to communicate with others from a foreign country. Unfortunately, many of the employees within these divisions may speak only their native language. However, the benefits of being able to communicate with other employees in their native language are bountiful. For example, learning to speak another language enables the employees to “step inside the mind and context of that other culture,” which in turn allows the employees to reduce mistrust and/or misunderstandings, and to improve cooperation. Learning to speak another language also enables the business to grow in the other countries, to make more sales and to negotiate and secure contracts.

Unfortunately, learning another language takes time and effort. Learning another language often becomes more different if the sounds of the language are unfamiliar to the student. Taking classes where one has the opportunity to practice speaking the language may sometimes be insufficient. This is especially true where the student is attempting to learn the language at a different pace than the class. Moreover, while there are a plethora of language software programs, audio tapes, books, and even language learning websites, these too are often offered in classroom type structures, limiting a student from branching forth into learning the language at their own pace or based on text they may be more interesting or relevant to the student. Moreover, simple translation tools are often merely that—a mechanism for merely translating text, without providing much more for the student. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention;

FIG. 4 illustrates a logical flow diagram generally showing one embodiment of a process for managing a language learning environment that enables text to speech conversion and download of related audio files; and

FIGS. 5-10 generally show example embodiments of user interfaces useable within a language learning component.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It should be noted that while the context of the term “language” should be clear, as used herein, the term “language” refers to a system of visual, auditory, or tactile symbols of human communication and the rules used to manipulate them. Thus, for example, the term language as used herein is not directed computer programming languages, such as FORTRAN, C, PASCAL, or the like. Instead, it is directed towards, such non-exhaustive languages as English, Chinese, Japanese, and so forth. Moreover, as used here, the term “native” language refers to a language that is native to a user visiting a network device over the network, while the term “foreign” language refers to a language in which the content provided by the network device is displayed or otherwise employs. While a user may be versed in a plurality of languages, used herein, the native language of the user is presumed to be different from the foreign language used for the content being accessed by the user.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments of the invention are directed towards a language learning environment accessible from within virtually any website that enables a user to practice a language using tools such as translators, and text to speech capabilities. In one embodiment, the tools are accessible through a widget displayable within the website. In one embodiment, virtually any website owner may incorporate the widget into the website for a user to access. In another embodiment, the user may download a client language widget that is displayable over at least a portion of a website. In one embodiment, the user may access a webpage in one language, and employ the language widget to select portions of content on the webpage, perform translation of the content, and in particular, perform a text to audio (speech) conversion of the selected portions. In one embodiment, the text to speech conversion may be performed independent of translation, thereby allowing the user to hear a pronunciation of text within the website in native language of the website. In one embodiment, the text to speech conversion may include a visual display of the selected text with pronunciation guides. In one embodiment, the user may select to download an audio file of the converted text for use in later replay. In another embodiment, the user may pre-configure their client device for automatic download onto a pre-defined mobile device such that the user may subsequently use the audio file for mobile learning. Thus, a user is provided with a flexible language environment that may be used for virtually any website to assist the user in learning a language upon which the website is premised.

However, it should be noted that the invention is not constrained to merely website content, and content may be selected from any of a variety of sources, including, but not limited to documents, screen shots, desktop displays, audio books, word processing documents, such as WORD documents, text files, WORDPERFECT documents, or the like.

It is noted that while the FIGURES illustrate example uses of the invention within the context of the Chinese language, the invention is not so limited. Virtually any language oriented webpage may incorporate the language widget for use with the webpage, and/or website. Thus, for example, the language widget may be incorporated into webpages in English, Russian, Korean, Spanish, or the like, to name just a few possible languages, without narrowing the scope of the invention.

### Illustrative Operating Environment

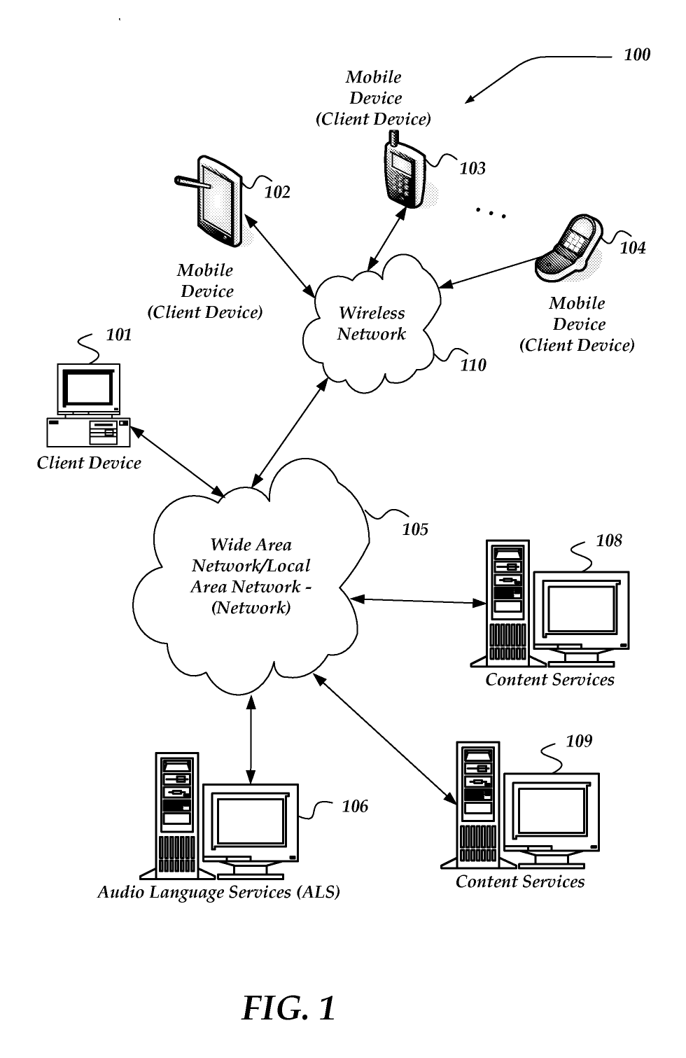

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, client devices 101-104; content services 108-109, and Audio Language Services (ALS) 106.

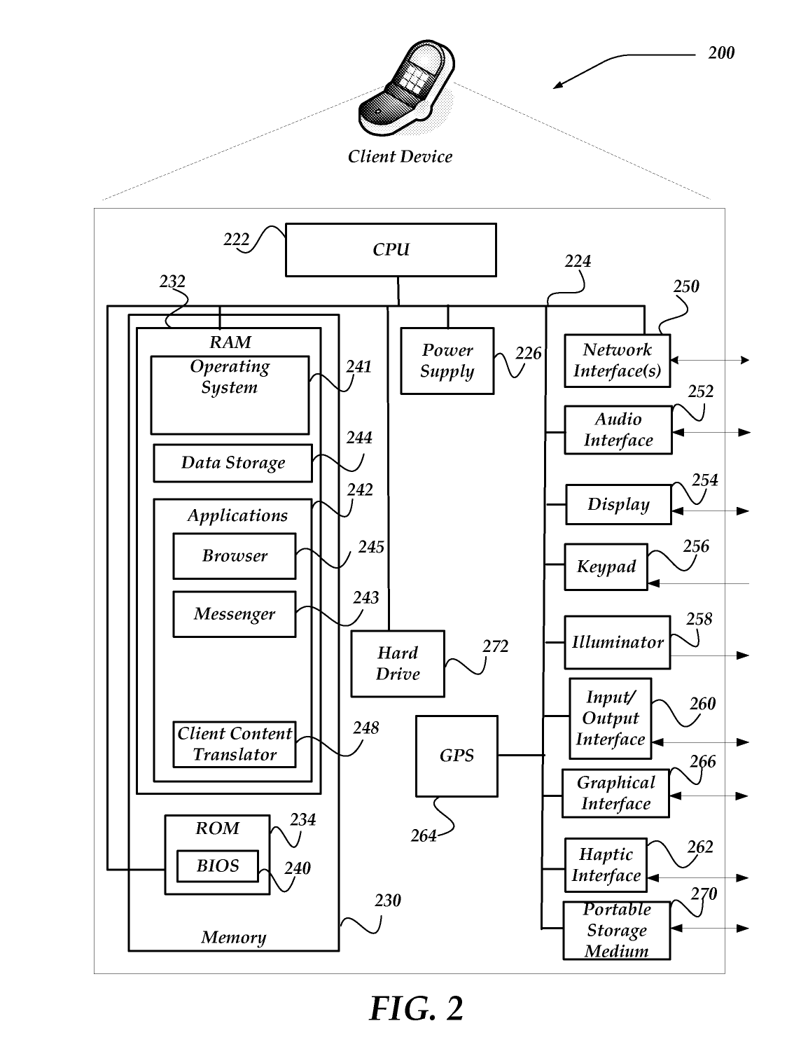

One embodiment of a client device usable as one of client devices 101-104 is described in more detail below in conjunction with FIG. 2. Briefly, however, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send webpages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-104 also may include at least one other client application that is configured to receive content from another computing device, including, without limit, content services 108-109. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to include a client application that enables the user to log into a user account that may be managed by another computing device. Such user account, for example, may be configured to enable the user to receive emails, send/receive IM messages, SMS messages, access selected webpages, download scripts, applications, or a variety of other content, or perform a variety of other actions over a network. However, managing of messages or otherwise accessing and/or downloading content, may also be performed without logging into the user account.

Thus, a user of client devices 101-104 may employ any of a variety of client applications to access content, read webpages, receive/send messages, or the like. In one embodiment, for example, the user may employ a browser or other client application to access a webpage hosted by content services 108-109. In one embodiment, a user of one of client devices 101-104 may access one of content services 108-109, where the content services 108-109 might provide content, including webpages, in a language that may be foreign to the user. For example, the user might be a native of China, U.S.A., or some other country. That is, the user's native language might be Mandarin Chinese, English, or some other language. However, the content accessible from one of content services 108-109 might be in a different language than the native language of the user. For example, while the user's native language might be Mandarin Chinese, the content displayed at one of content services 108-109 might be in English—or still some other language. While, in some situations, such content might provide a level of frustration to a user, it also may provide an opportunity for other users to attempt to learn a foreign language, culture, or the like. Thus, in one embodiment, client devices 101-104 might access for download, or find located at the website hosted by one of content services 108-109 a language tool that enables the user to select their native language, and to provide among other services, a language translation service, a dictionary, search tools, and a text to speech capability within an integrated environment.

Thus, in one embodiment client devices 101-104 may be further configured to download a plug-in, script, application, or other component, useable to provide language learning services, including a text to speech function. Moreover, in one embodiment, the downloadable component may enable the user to download onto a mobile device, such as client devices 102-104, an audio file of at least a portion of speech converted from text that the user selects from the website. In this way, the user is provided with an integrated approach for capturing audio pronunciations of text in a foreign language for subsequent mobile learning. However, the invention is not limited to use of a downloadable component, and in another embodiment, an owner of at least one of content services 108-109 may enable their website to include display of a language component that may provide features substantially similar to the downloadable component, including but not limited to text to speech conversation, and ability to download an audio file for use in subsequent language learning of at least pronunciations of selected content.

In one embodiment, the downloadable component and/or language component accessible at a website may be configured with a default native language that is assumed to be associated with the accessing user, and a foreign language that is based on the language used for the content at the website. However, in another embodiment, the downloadable component and/or language component accessible at a website may be configured to determine a user's native language based, in part, on a device identifier. That is, in one embodiment, the device identifier may be useable to identify a geographic location of the client device. The geographic location may then be used to provide an initial native language indication for which the invention may use in translations, or other language related activities. However, in another embodiment, the user may be provided a mechanism by which the native language may be modified. In one embodiment, the downloadable component and/or language component may employ the native language to provide instructions on its use, or the like. However, in another embodiment, the user may select a language for which the component(s) display instructions, help, and the like. Thus, in one embodiment, where the user might seek emersion into the foreign language, the user might select that the component's instructions also be displayed in the foreign language.

Wireless network 110 is configured to couple client devices 102-104 to network 105. Wireless network 110 may include any of a variety of wireless sub-networks that may further overlay stand-alone ad-hoc networks, and the like, to provide an infrastructure-oriented connection for client devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as client devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 105 is configured to couple RTS 106 and its components with other computing devices, including, client devices 102-104, and through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between RTS 106, and other computing devices.

Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

Content services 108-109 include virtually any computing device that is configured and arranged to provide any of a variety of content and/or services over a network. As such, content services 108-109 may operate as a website for enabling access to such content/services including, but not limited to blog information, educational information, music/video information, social networking content and/or services, messaging, or any of a variety of other content/services. However, content services 108-109 are not limited to web servers, and may also operate a messaging server, a File Transfer Protocol (FTP) server, a database server, or the like. Additionally, each of content services 108-109 may be configured to perform a different operation. Thus, for example, content provider 108 may be configured as a website server for multimedia content, while content service 109 is configured as a database server for a variety of content. Moreover, while content services 108-109 may operate as other than a website, they may still be enabled to receive an HTTP communication.

In one embodiment, content services 108-109 may provide content in a language that may be foreign to a visitor's native language. In one embodiment, content services 108-109 may provide a hyperlink or the like to another network device, such as ALS 106, for use in accessing a client downloadable language component. However, in another embodiment, at least one of content services 108-109 may also be configured to include a language component accessible for use by a visitor independent of downloading the component onto a client device. In one embodiment, the language component may be displayed as a pop-up widget, menu, frame, window, or the like. In one embodiment, the language component may appear to ‘float’ over at least a portion of content displayed at the at least one content services 108-109. In another embodiment the content may be displayed in a manner such that the displayed portion of the language component does not obscure the content. Thus, the integration of the content with the language component may be arranged in a variety of approaches, and other approaches are envisaged as within scope of the invention.

Devices that may operate as content services 108-109 include personal computers, desktop computers, multiprocessor systems, microprocessor-based or programmable consumer electronics, network PCs, servers, and the like.

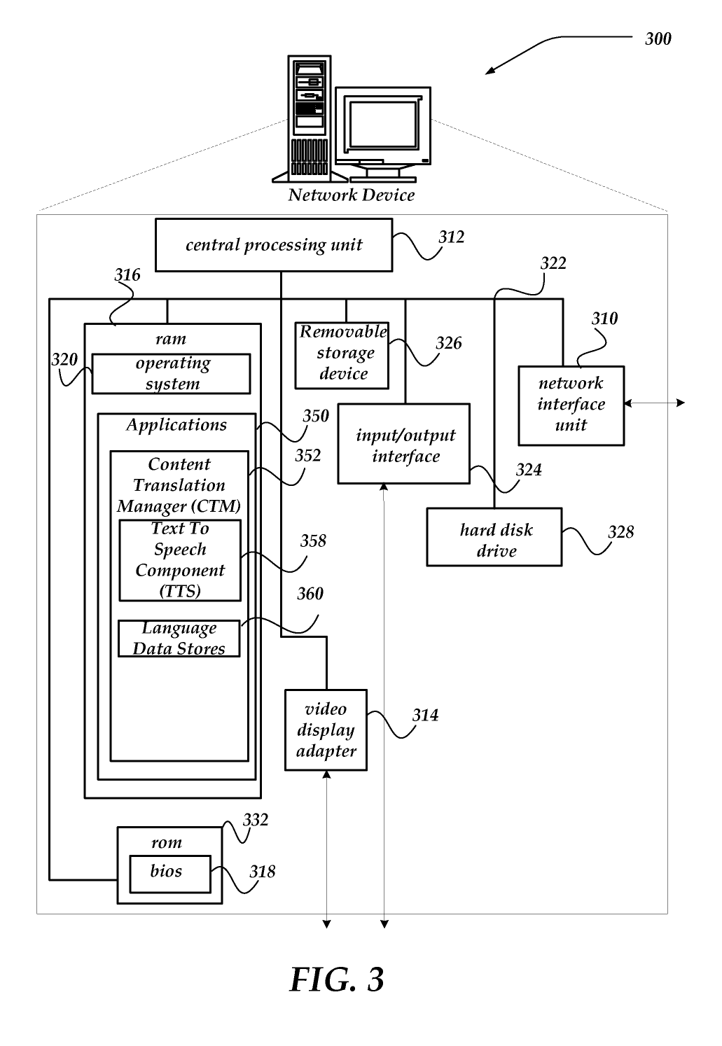

One embodiment of Audio Language Services (ALS) 106 is described in more detail below in conjunction with FIG. 3. Briefly, however, ALS 106 includes virtually any network device that may be configured and arranged to provide a language learning environment in which a user practicing a language may employ a real-time language text to speech capability with automatic download for mobile learning.

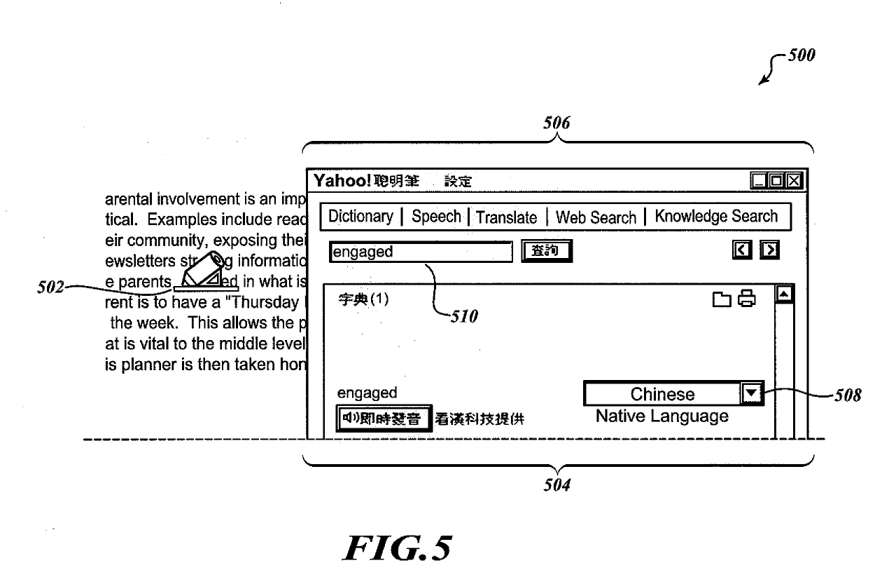

In one embodiment, ALS 106 may provide access to a downloadable client language component. As noted above, the downloadable client language component may be configured to enable a visitor of a website to employ an integrated language environment that allows the visitor to perform such actions as obtaining a definition of content within a website hosted by content services 108-109; translate content within the website; perform searches related to content within the website; and to perform real-time language text to speech capability of portions of the content within the website. Such actions, as well as others are described in more detail below in conjunction with FIGS. 5-10.

ALS 106 may further operate as a data store for back-end services employable by either the downloadable client component and/or a language component integrated within a webpage at content services 108-109. Thus, ALS 106 may receive information about a client device being employed to access content at content services 108-109, and employ the received information to determine a default native language for a user of the visiting client device. ALS 106 may then provide data to the language components such that the downloaded client component is configured with at least the default native language. Moreover, ALS 106 may use the default native language to send data to content services 108-109 such that instructions, help, and other information displayed within the language component, may be displayed using the default native language. ALS 106 may also receive information through the visiting user that may be used to change the default native language to another language.

In one embodiment, received information is a device identifier that may be useable to determine a geographic location, and therefore, a possible native language of the visiting user. However, in another embodiment, the user might be requested when visiting content services 108-109, or when requesting the downloadable component, to identify a native language.

ALS 106 may further be configured to provide language data stores that may be useable to translate content from one language to another, provide dictionary definitions of content, enable web searches, enable knowledge searches, or the like. Moreover ALS 106 may include a data store that enables a user to receive audio files useable to hear pronunciations of selected content within content services 108-109. In one embodiment, ALS 106 may also allow the visiting user to identify a location for storage of the audio files onto a mobile device, or other client device. In one embodiment, the language component may enable the user to specify that audio files are to be automatically downloaded when a user selects such text to speech function for selected content. Thus, in one embodiment, ALS 106 may provide a variety of back-end services useable by the language components to provide an integrated language environment with text to speech capability.

In one embodiment, ALS 106 may also be configured to select and/or otherwise provide advertisements that may be displayed within a language component. Such advertisements may be selected based on content selected by a visiting user of content services 108-109 based on a theme, or other characteristic of content displayable at content services 108-109; based on a relationship agreement with an owner of content services 108-109; or based on a variety of other criteria. Moreover, ALS 106 may select to display the advertisements within the visiting user's native language, and/or in the language of the content of content services 108-109.

Devices that may operate as ALS 106 include personal computers desktop computers, multiprocessor systems, microprocessor-based or programmable consumer electronics, network PCs, servers, and the like. Although FIG. 1 illustrates ALS 106 as a single computing device, the invention is not so limited. For example, one or more functions of ALS 106 may be distributed across one or more distinct computing devices, without departing from the scope or spirit of the present invention.

### Illustrative Mobile Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252 that may be configured to receive an audio input as well as to provide an audio output, a display 254, a keypad 256, an illuminator 258, an input/output interface 260, a haptic interface 262, and a global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery. Client device 200 may also include a graphical interface 266 that may be configured to receive a graphical input, such as through a camera, scanner, or the like. In addition, client device 200 may also include its own camera 272, for use in capturing graphical images. In one embodiment, such captured images may be evaluated using OCR 268, or the like.

Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications and/or other data. For example, data storage 244 may also be employed to store information that describes various capabilities of client device 200, a device identifier, and the like. The information may then be provided to another device based on any of a variety of events, including being sent as part of a header during a communication, sent upon request, or the like.

In one embodiment, data storage 244 may also include downloadable audio files obtainable from use of client content translator 246 or a remote language component. In this manner, client device 200 may maintain, at least for some period of time, audio files that may then be useable for remote mobile learning, or the like. Data storage 244 may further include cookies, and/or user preferences including, but not limited to a default native language, user interface options, and the like. At least a portion of the capability information, audio files, and the like, may also be stored on an optional hard disk drive 272, optional portable storage medium 270, or other storage medium (not shown) within client device 200.

Applications 242 may include computer executable instructions which, when executed by client device 200, transmit, receive, and/or otherwise process messages (e.g., SMS, MMS, IMS. IM, email, and/or other messages), audio, video, and enable telecommunication with another user of another client device. Other examples of application programs include calendars, browsers, email clients, IM applications, VOIP applications, contact managers, task managers, database programs, word processing programs, security applications, spreadsheet programs, games, search programs, and so forth. Applications 242 may further include browser 245, messenger 243, and Client Content Translator (CCT) 248.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed.

Browser 245 may be configured to enable a user to access a webpage, and request access to a language component useable to learn a foreign language in which the webpage is displayed. In one embodiment, browser 245 may be used to request a downloadable client language component, such as CCT 248. In one embodiment, CCT 248 may operate as a separate application, widget, or the like. However, in another embodiment, CCT 248 may be configured as a plug-in to browser 245. In another embodiment, browser 245 may access a webpage, website, or the like, with which a language component is integrated.

Thus, CCT 248 may represent an optionally downloadable component useable to enable a user to learn a foreign language. CCT 248 or a site from which CCT 248 is to be downloaded from may initially determine a default native language for a user of client device 200. In one embodiment, a device identifier may be used to lookup a geographic location for the client device. For example, if the device identifier is a phone number, ESN, MIN, or the like, the number may be used to identify a country, state, county, district, region, or the like. This information may then be used to initially identify a default native language. However, CCT 248, and/or the download site may also enable the user to modify the default native language.

CCT 248 may then provide a user with an integrated language environment for websites, documents, text files, audio books, or the like. CCT 248 may provide for example, dictionary services, search capabilities, and even a text to speech capability, where the user may download in real-time audio files useable for mobile learning of a foreign language, including a pronunciation of the language. Moreover, in one embodiment, CCT 248 may provide an interface to the user such as those described in more detail below in conjunction with FIGS. 5-10.

### Illustrative Server Environment

FIG. 3 shows one embodiment of a network device, according to one embodiment of the invention. Server device 300 may include many more components than those shown. The components shown, however, are sufficient to disclose an illustrative embodiment for practicing the invention. Server device 300 may represent, for example, ALS 106 of FIG. 1.

Server device 300 includes processing unit 312, video display adapter 314, and a mass memory, all in communication with each other via bus 322. The mass memory generally includes RAM 316, ROM 332, and one or more permanent mass storage devices, such as hard disk drive 328, and removable storage device 326 that may represent a tape drive, optical drive, and/or floppy disk drive. The mass memory stores operating system 320 for controlling the operation of server device 300. Any general-purpose operating system may be employed. Basic input/output system (“BIOS”) 318 is also provided for controlling the low-level operation of server device 300. As illustrated in FIG. 3, server device 300 also can communicate with the Internet, or some other communications network, via network interface unit 310, which is constructed for use with various communication protocols including the TCP/IP protocol, Wi-Fi, Zigbee, WCDMA, HSDPA, Bluetooth, WEDGE, EDGE, UMTS, or the like. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Applications 350 may also include Content Translation Manager (CTM) 352, which may include Text To Speech component (ITS) 358, and language data stores 360.

Language data stores 360 includes a plurality of language stores and may include one or more databases, language search tools, dictionaries, video clips, audio clips, images, or the like for each of the plurality of languages. By making a plurality of languages available virtually real-time language translation/interpretation/education services may be provided to a user.

ITS 358 enables text to be received, converted to speech for play by a user. In one embodiment, the speech may be provided to the user as a streaming audio file, or as a downloadable audio file. In one embodiment, the user select to have at least a first play of the audio file automatically downloaded to a designated location on a client device. In another embodiment, the user may be provided with a user interface that enables the user to select when and where to download the audio file. Moreover, while the audio file may be provided in one format, such as an MP3 audio file, various embodiments may further allow a user to select a format for which the audio file may be provided.

ITS 358 may provide an interface selection capability to allow a user to select a speed of play of a text to speech audio file. Thus, in one embodiment, a user might be provided with a pull down menu, a slider bar, or the like, that enables the user to change a speed of play of the audio file.

ITS 358 may also provide an interface that enables the user to view pronunciation assists, using, for example, that may employ any of a variety of aids, including but not limited to using the International Phonetic Alphabet, a Romanization scheme, a Cyrillization scheme, or the like. Thus, where a foreign language might use symbols, such as Chinese characters, for example, a common pronunciation approach such as Pinyin Romanization might be employed. However, other pronunciation aids may also be provided.

CTM 352 is configured and arranged to provide back-end services to a language component that is integrated into a website or webpage, and/or is a client downloadable component.

In one embodiment, CTM 352 may further provide the language components for downloading or integration. Thus, a content services owner, administrator, or the like, or a user of a client device, may request access to the language component from CTM 352. CTM 352 may then determine, in one embodiment, a default configuration for language component, including a default native language, or the like, in response to the request. CTM 352 may further configure the language component for at least one default foreign language, such as might be determined based on a webpage with which the component is to be integrated, or the like.

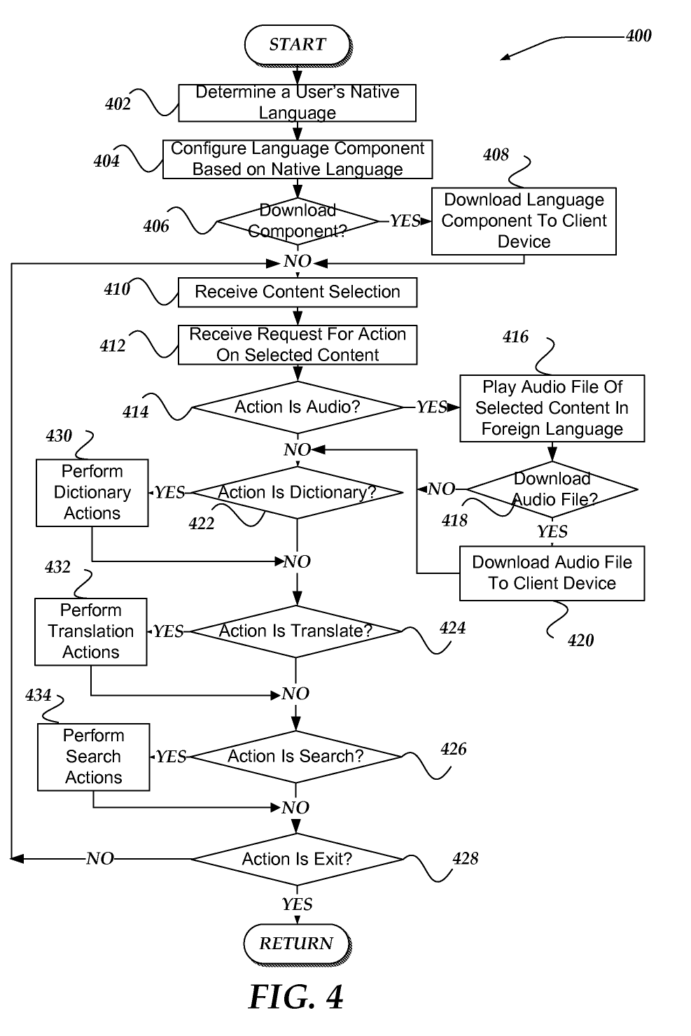

Moreover, CTM 352 may provide language components and functions such as are described in more detail below in conjunction with FIGS. 5-10. In addition, CTM 352 may employ a process substantially similar to that described below in conjunction with FIG. 4 to perform at least some of its actions.

### Generalized Operation

The operation of certain aspects of the invention will now be described with respect to FIG. 4. FIG. 4 illustrates a logical flow diagram generally showing one embodiment of a process for managing a language learning environment that enables text to speech conversion and download of related audio files. Process 400 may be performed by ALS 106 of FIG. 1, in one embodiment. However, in another embodiment, a language component may be configured to operate virtually independent of a remote service such as ALS 106. Thus, in one embodiment, a downloadable language component, or a website with an integrated language component may be configured to perform process 400. Moreover, process 400 may provide user interfaces such as are described below in conjunction with FIGS. 5-10 to perform at least some of the actions described within process 400.

As shown, process 400 begins, after a start block, at block 402, where a request for access to a language component is received. During block 402, the language component may be configured for use, in one embodiment, by determining an accessing user's native language. In another embodiment, however, the language component might be configured for a default native language, and might not be configurable. In any event, if the language component is configurable, then, at block 402 the default native language may be determined. In one embodiment, such determination might involve having the user select a native language for which the user would be enabled to see help guides, instructions, and so forth within the language component. In another embodiment, the native language might be automatically determined based on receiving a device identifier from a client device associated with the accessing user. Using the device identifier, a search might then be performed to determine a geographic location of the client device, based on the device identifier. A language associated with the determined geographic location might then be selected as the determined native language. Processing then flows to block 404 where the determined native language is used to select the language component for display, or otherwise configure the language component.

Processing continues next to decision block 406, where a determination is made whether the language component is to be downloaded and installed onto the user's client device. If it is to be downloaded, processing flows to block 408; otherwise, processing continues to block 410. It should be noted, that in one embodiment, the user might be accessing a website which includes the language component for the user to employ. In such a situation, the user might not be provided with an option to download the language component. Moreover, in one embodiment, the language component integrated with the website might be pre-configured for a native language. Moreover, where the language component is integrated with the website, the language component may be pre-configured for use with the ‘foreign’ language used to provide content at the website. Thus, in one embodiment, it may be that the user's native language is different from the ‘foreign’ language of the website.

At block 408, the language component may be downloaded and installed onto the client device. In one embodiment, the client language component may be configured to be ‘self-contained’ in that it may include any data stores for dictionaries, translators, or the like. However, in another embodiment, the client language component may access such data stores from a remote network device. Processing flows next to block 410.

At block 410, the user may employ the language component to select content. In one embodiment, the content may be selected from a visited website. It should be noted, that while process 400 illustrates use of content from a website, the invention may also enable the user to select content from virtually any other source, including, but not limited to local documents, files, word processing files, text files, audio books, or the like. Thus, while web content is illustrated for one example, such illustration is not to be construed as limiting the invention in any manner.

Processing flows next to block 412, where using the language component the user may then request an action to perform upon the selected content. Thus, processing flows to decision block 414, where a determination is made whether the requested action is for a text to speech action. If so, processing flows to block 416; otherwise, processing flows to decision block 422.

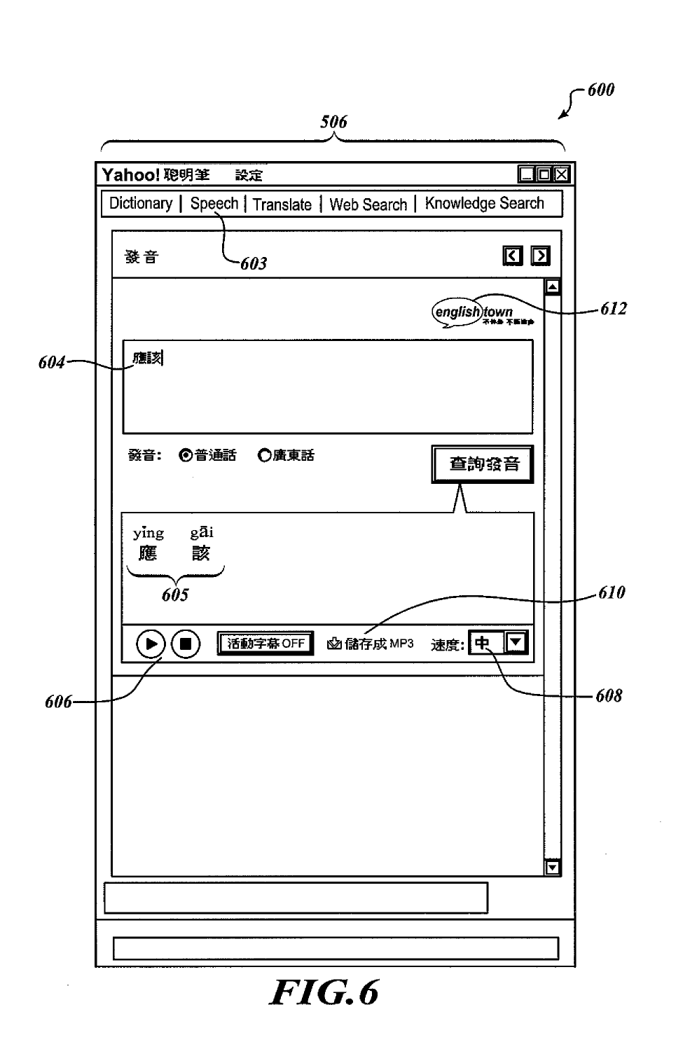

At block 416, an interface is displayed such as described below in conjunction with FIG. 6 that enables the user to play an audio file of the selected content, in the foreign language. Moreover, also shown might be a mechanism that illustrates pronunciation of the selected content, such as using phonics, or the like. The user may then play the audio file as many times as desired and even select a speed for the play of the audio file.

Continuing to decision block 418, the user may select to download the audio file for use in mobile learning. In one embodiment, the user may employ the interface to select to download the audio file, and/or configure the interface to automatically download audio files, and/or select a format in which the audio file is to be downloaded. If the user selects to have the audio file downloaded, processing flows to block 420, where the user's selections may be employed to download the audio file onto a client device and/or other location designated by the user. Processing then flows to decision block 422. If the user selects not to download the audio file, processing also flows to decision block 422.

At decision block 422, if the selected action by the user is to employ a dictionary on the selected content, processing flows to block 430, where a native/foreign language dictionary definition of the selected content may be displayed. In one embodiment, the user may also be provided with encyclopedia information as well. In one embodiment, the user may select sections of the definitions for further exploration of the selected content, related definitions, or the like. Processing then flows from decision block 422 if the user did not select a dictionary action, or from block 430 otherwise, to decision block 424.

At decision block 424, a determination is made whether the selected action is to perform a translation of the selected content from the foreign language to the native language. If so, processing flows to block 432; otherwise, processing flows to decision block 426. At block 432, the selected content is translated, and a result displayed through the interface for the user. Processing then flows to decision block 426.

At decision block 426, if the selected action by the user is to perform a search, processing flows to block 434; otherwise, processing flows to decision block 428. At block 434, the search may be a web search, a knowledge search, or the like, based on the selected content.

Processing then flows to decision block 428.

At decision block 428, a determination is made whether the user has selected to exit the language component. If so, processing returns to a calling process to perform other actions. Otherwise, processing loops back to block 410 to allow the user to select other content. It should be noted, that while the user may select content, the invention also enables the user to enter content into a field within the interface that may then be used by process 400 substantially similar to content selected from within the website, a document, file, or the like.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Illustrative User Interfaces

Below are described various user interfaces useable by a language learning component, in conjunction with FIGS. 5-10. FIGS. 5-10 may include many more or less components than those shown. However, the components shown are sufficient to disclose an illustrative embodiment for practicing the present invention. Moreover, it should be noted, that such examples of user interfaces are not to be considered as exhaustive, and therefore are not to be construed as limiting the scope of the invention. For example, other user interfaces useable by a language learning component are described within U.S. patent application Ser. No. 11/190,685 entitled “Automatically Generating a Search Result in a Separate Window for a Displayed Symbol That Is Selected with a Drag and Drop Control” filed on Jul. 27, 2005, which is incorporated herein by reference. In that application, for example, various drag and drop mechanisms are employed to select text virtually anywhere within a display area with a pointing device such as a mouse, or the like. In one embodiment, the selection mechanism may be illustrated to a user using an animated image, a pen icon, an emoticon, or the like. In one embodiment, the selection mechanism may be configured to blink, change colors, rotate, and/or perform a variety of other actions to assist a user in locating and moving the selection mechanism, highlighting a selection of content, or otherwise in enhancing a use of the selection mechanism.

FIG. 5 illustrates one non-exhaustive example 500 of an embodiment of a language learning component 504 that is shown to overlay content. Such content may be within a webpage, or even within a document, or other file. However, the invention is not so limited, and the content may also be within a computer ‘background’ image, ‘screen saver,’ or the like. Thus, the source of content for which the language learning component may be applied to is not limited to web content. Moreover, while language learning component 504 is shown as overlaying the content, in one embodiment, a user may drag and relocate, and even resize language learning component 504. Thus, in one embodiment, language learning component 504 may be relocated virtually anyplace within a display screen.

As shown in FIG. 5, selection mechanism 502 may be used to select content. Selection of the content may be performed by underlining content, encircling the content, highlighting the content, or any of a variety of actions useable to delineate content. In one embodiment, the selected content may be illustrated within a display window 510 within language learning component 504. Although only a single word is illustrated, the invention is not limited to single word selections, and virtually any quantity of content may be selected.

When the content is selected, the user then employ different language action, including those illustrated in action bar 506. As shown, action bar 506 describes possible actions, in English for ease of illustration of the invention. However, such selections within action bar 506 may be illustrated in another language, such as a native language of the user, selected as a default native language, and/or modified by the user, such as through native language selector 508, or the like. In any event, action bar 506 illustrates selectable actions, including, a dictionary, a text to “speech” action, a translate action, a web search, and a knowledge search. However, other actions may also be included, including, but not limited to selecting encyclopedias, selecting synonyms, homonyms, or the like. In any event, FIGS. 6-10 provide possible non-exhaustive examples of embodiments of several of the selector actions illustration in FIG. 5.

For example, FIG. 6 illustrates one example embodiment of language learning component interface 600 when a user selects the text to ‘speech’ action 603. As shown, selected text 604 may be shown in a window, or other the like. Moreover, a pronunciation assist 605 is also illustrated. As shown in this embodiment, the user may have indicated that the language selected is Chinese, and thus, the user is seeking, not a translation of the Chinese into another language, but rather an opportunity to hear the text pronounced and to learn how to pronounce the text. Thus, the pronunciation assist 605 may illustrate how to pronounce the Chinese.

In addition, a user may select audio buttons 606 to play an audio file that indicates how the selected content might sound in that same language. Thus, playing the audio file for this example, the Chinese pronunciation of the selected content may be performed, paused, and/or replayed. In one embodiment, speed selector 608 may allow the user to modify a speed in which the audio file is played.

In one embodiment, downloader 610 provides the user with an ability to select to download an audio file of the pronunciation of the selected content. As shown, the audio file may be downloaded using a default file format, such as MP3, or the like. However, the invention is not limited to this format, and other audio file formats may also be used. Moreover, in one embodiment, downloadable 610 may further allow a user to select a file format in which the audio file is to be downloaded. It is noted that, while in one embodiment, downloader 610 may be used to enable a user to select to download the audio file, in another embodiment, downloader 610, or another selector may be used to configure language learning component interface 600, such that automatic downloads might be performed. Thus, in one embodiment, the user might select that upon a first play of the audio file, or upon selection of ‘speech’ action 603, or based on some other event, the audio file might be automatically downloaded to a defined location for use in mobile learning.

While language learning component interface 600 is configured to enable a user to obtain text to speech for selected content, the invention may also provide an opportunity for providing sponsored advertisements, such as advertisement 612, to a user. Thus, in one embodiment, a website owner, or other source, might monitor various activities of a user of the present invention, and then based on the user behavior, a selected language, a native language, selected content, or a variety of other criteria, provide advertisement 612 to the user. However, advertisement 612 is not limited to advertisements, and upgrade announcements, educational information, or the like, might also be provided through advertisement 612, without limiting the scope of the invention.

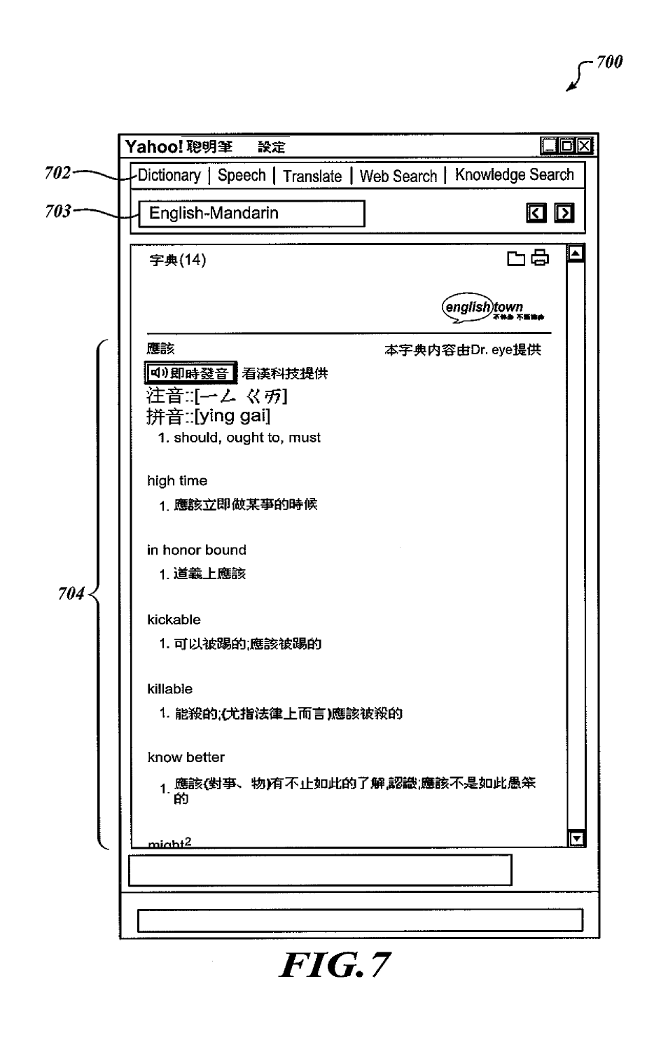

FIG. 7 illustrates one non-exhaustive example of an embodiment of a language learning interface 700 useable when a user selects to employ a dictionary 702 selection. In one embodiment, the dictionary may provide definitions in a native language for the user of selected content that is in a foreign language. In one embodiment, language indicator 703 may indicate the languages for interface 700. In one embodiment, however, the language indicator 703 may enable a user to modify the languages involved. In any event, definitions of the selected content may be provided within interface 700 within a scrollable window 704, or the like.

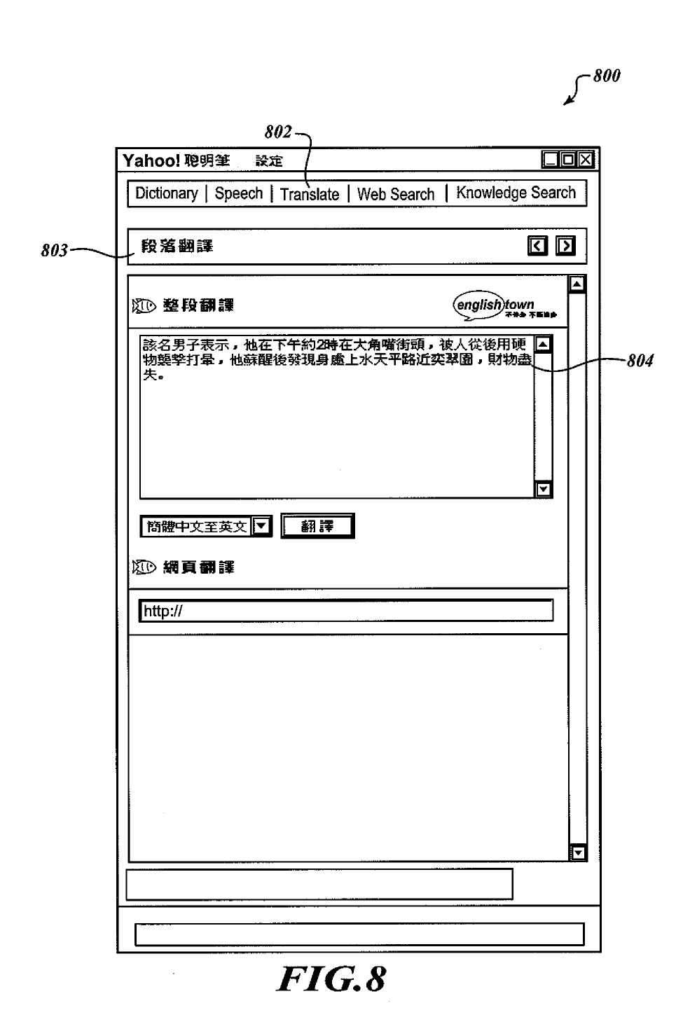

FIG. 8 illustrates one non-exhaustive example of an embodiment of a language learning interface 800 useable when a user selects to employ a language translation 802 selection. As shown, selected content 803 may selected to multi-lingual translations as shown in translation 804.

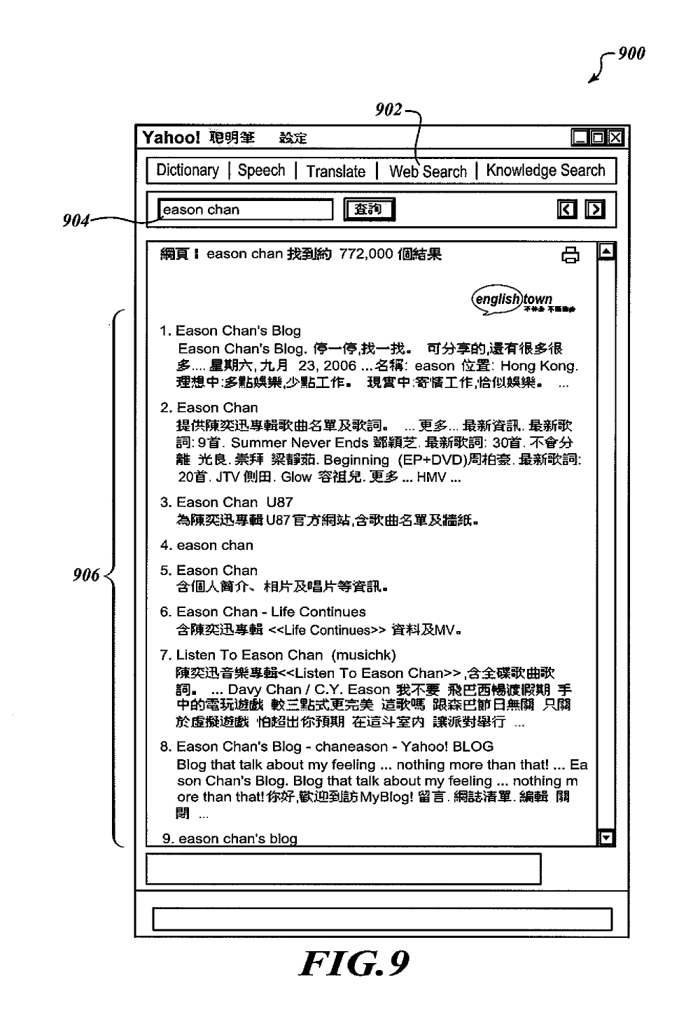

FIG. 9 illustrates one non-exhaustive example of an embodiment of a language learning interface 900 useable when a user selects to employ a web search 902 selection. As shown, selected content 904 may employed to provide initiate a web crawler, or other action, configured to provide a web search result 906. As shown, in one embodiment, web search result 906 may be shown in a native/foreign language context to encourage the language learning.

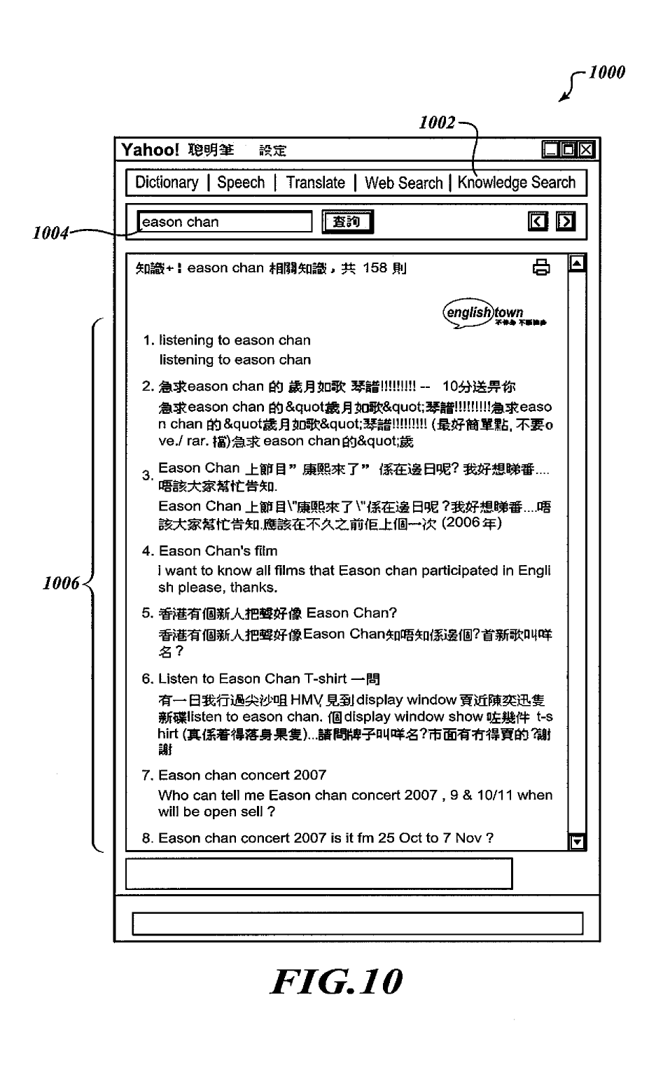

FIG. 10 illustrates one non-exhaustive example of an embodiment of a language learning interface 1000 useable when a user selects to employ a knowledge search 1002 selection. As shown, selected content 1004 may employed to provide a database search application, focused web crawler, or the like, to search for results 1006 that are directed towards providing the user with additional information about the selected content 1004. As shown, in one embodiment, the results 1006 may be shown in a native/foreign language context to encourage the language learning.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A computer-readable storage medium that includes data and instructions, wherein the execution of the instructions on a computing device provides for managing communications over a network by enabling actions, comprising:
accessing content over the network, wherein the content is in a first language and where in a user accessing the content is associated with a second language, and wherein the first language and the second language are different;
selecting at least a portion of the content;
receiving a display of information indicating how to pronounce the selected content in the first language, and
allowing the user to play an audio file of the selected content converted to speech, such that the user is provided with an audio play in the first language.

2. The computer-readable storage medium of claim 1, wherein the user is further provided with a selectable mechanism to download the audio file onto a client device, such that the downloaded audio file enables mobile learning of the first language.

3. The computer-readable storage medium of claim 2, wherein the data and instruction enable actions, further comprising:
receiving a device identifier associated with a client device for the user;
determining a geographic location of the client device based on the received device identifier; and
determining the second language based on the determined geographic location.

4. The computer-readable storage medium of claim 1, wherein the data and instruction enable actions, further comprising providing a user interface, for use in enabling the user to display the information, and play the audio file, wherein at least one instruction for use of the user interface is in the second language.

5. The computer-readable storage medium of claim 4, wherein the user interface further enables the user to select content for at least one of a translation from the first language to the second language, or performing a search wherein a result of the search is at least in part in the first language.

6. The computer-readable storage medium of claim 1, wherein the data and instruction enable actions, further comprising providing a language learning component that is integrated within at least a portion of content.

7. A method for managing a communications over a network, comprising:
accessing a webpage over the network, wherein content on the webpage is displayed using a first language;
displaying at the webpage an interface to a language learning component that is configured and arranged to enable a user to perform language learning actions;
enabling the user to select a portion of content on the webpage using the interface;
providing through the interface an audio file of the selected portion of content in the first language with a pronunciation guide; and
enabling the user to download the audio file onto a client device for mobile learning of the first language.

8. The method of claim 7, wherein at least one instruction associated with the interface is displayed in a second language that is different than the first language, and wherein the second language is determined to be a native language of the user.

9. The method of claim 7, wherein at least a portion of the interface is displayed using a second language, wherein the second language is determined based in part on determining a geographic location of the client device.

10. The method of claim 7, wherein the interface is configured to allow the user to select a format of the audio file.

11. The method of claim 7, wherein the interface further provides at least one sponsored advertisement to the user using at least one of the first language or a second language determined to be a native language of the user, and wherein the first language and the second language are different.

12. A network device to manage a communications over a network, comprising:
a transceiver to send and receive data over a network; and
a processor that is operative to perform actions, comprising:
providing for display on a webpage an interface to a language learning component that is configured and arranged to enable a user to perform at least one language learning action, and wherein content at the webpage is displayed in a first language, and at least a portion of the interface is displayed in a second language that is different from the first language;
receiving a selection of a portion of content on the webpage through the interface, wherein the user employs the interface to select the portion of content;
providing through the interface an audio file of the selected portion of content in the first language with a pronunciation guide, wherein the audio file is playable for the user through the interface; and
enabling the user to download the audio file onto a client device for mobile learning of the first language.

13. The network device of claim 12, wherein the at least one language learning action further comprises performing at least one or a dictionary lookup or a search based on the selected portion of the content.

14. The network device of claim 12, wherein the second language is determined to be a native language of the user based on a client device identifier.

15. The network device of claim 12, wherein the interface enables the user to select a format in which the audio file is to be downloaded.

16. The network device of claim 12, wherein the portion of the interface is displayed in the second language further comprises displaying at least one instruction for use of the interface in the second language.

17. A mobile device for enabling a communications over a network, comprising:
a memory arranged to store data and instructions;
an input interface for receiving requests and sending responses; and
a processor arranged to enable actions embodied by at least a portion of the stored instructions, the actions comprising:
accessing content over the network at a network device, wherein the content is displayed using a first language;
accessing a language learning component at the network device, wherein the language learning component is configured to display at least one instruction in a second language, wherein the first and second languages are different;
selecting at least a portion of content at the network device using the language learning component; and
receiving an audio file for play, wherein the audio file is a text to speech conversion of at least the portion of content selected, wherein the speech conversion is played in the first language.

18. The mobile device of claim 17, wherein the language learning component further provides a pronunciation assist of the selected content for pronouncing the selected content in the first language.

19. The mobile device of claim 17, wherein receiving the audio file further comprises enabling selection of an audio file format for use in downloading the audio file to the mobile device.

20. The mobile device of claim 17, wherein the language learning component is further configured to be downloadable onto the mobile device.

21. The mobile device of claim 17, wherein the content is accessed from within at least one of an audio book, a text file, a graphic file, a desktop screen display, or a word processing document.
